(19) United States
(12) Patent Application Publication
(10) Pub. No.: US 2026/0112685 A1
(43) Pub. Date: Apr. 23, 2026

(54) NEGATIVE ELECTRODE ACTIVE MATERIAL, MANUFACTURING METHOD OF NEGATIVE ELECTRODE ACTIVE MATERIAL, NEGATIVE ELECTRODE COMPOSITION, NEGATIVE ELECTRODE FOR LITHIUM SECONDARY BATTERY INCLUDING THE SAME, AND LITHIUM SECONDARY BATTERY INCLUDING THE NEGATIVE ELECTRODE

(71) Applicant: LG ENERGY SOLUTION, LTD., Seoul (KR)

(72) Inventors: Seunggwan LEE, Daejeon (KR); Taeho KIM, Daejeon (KR); Sun Young SHIN, Daejeon (KR); Yong Ju LEE, Daejeon (KR)

(21) Appl. No.: 19/364,407

(22) Filed: Oct. 21, 2025

(30) Foreign Application Priority Data
Oct. 22, 2024 (KR) 10-2024-0144998

(51) Int. Cl. H01M 10/0525; H01M 4/02; H01M 4/36; H01M 4/38; H01M 4/587

(52) U.S. Cl. CPC H01M 10/0525; H01M 4/362; H01M 4/386; H01M 4/587; H01M 2004/021; H01M 2004/027

(57) ABSTRACT

A negative electrode active material for a lithium secondary battery, where the negative electrode active material includes a silicon-carbon (Si/C) composite having a modulus value (A) of about 15 GPa to about 25 GPa, and a hardness value (B) of about 2,500 MPa to about 5,000 MPa. The modulus value (A) represents the stiffness of a material and the hardness value (B) represents resistance to scratching or indentation on a material surface.

### CROSS-REFERENCE TO RELATED APPLICATIONS

This application is based on and claims priority to Korean Patent Application No. 10-2024-0144998 filed on Oct. 22, 2024, with the Korean Intellectual Property Office, the disclosure of which is incorporated herein in its entirety by reference.

### TECHNICAL FIELD

The present disclosure relates to a negative electrode active material, a method of preparing a negative electrode active material, a negative electrode composition, a negative electrode for a lithium secondary battery including the same, and a lithium secondary battery including the negative electrode.

### BACKGROUND

Due to the rapid increase in fossil fuel use, the demand for alternative or clean energy is increasing, and one of the most active areas of research is power generation and storage using electrochemical reactions.

A representative example of an electrochemical device that utilizes such electrochemical energy is a secondary battery, which is finding more and more applications.

In the meantime, as the technology development and demand for mobile devices increase, the demand for secondary batteries as an energy source is rapidly increasing. Among the secondary batteries, lithium secondary batteries, which have high energy density and voltage, relatively long cycle life, and low self-discharge rate, have been commercialized and are widely being used. In addition, research is actively being conducted on methods for manufacturing high-density electrodes with higher energy density per unit volume as electrodes for such high-capacity lithium secondary batteries.

### SUMMARY

In the present disclosure, during the process of depositing SiH₄ onto porous carbon in the course of manufacturing a silicon-carbon composite, the physical properties and composition of the porous carbon were adjusted and the deposition conditions were modified to improve the internal pore densification of silicon and to control the resistance to plastic deformation. As a result, the silicon-carbon composite manufactured under these conditions exhibited improved characteristics, such as reduced plastic deformation even when subjected to external pressing.

Accordingly, the present disclosure relates to a negative electrode active material according to the above-described technology, a method of preparing a negative electrode active material, a negative electrode composition, a negative electrode for a lithium secondary battery including the same, and a lithium secondary battery including the negative electrode.

An embodiment of the present disclosure provides a negative electrode active material for a lithium secondary battery including a silicon-carbon composite having a modulus (A) of about 15 GPa to about 25 GPa and a hardness (B) of about 2,500 MPa to about 5,000 MPa.

Another embodiment of the present disclosure provides a method for manufacturing a negative electrode active material for a lithium secondary battery, the method comprising: preparing porous carbon; and depositing silicon onto the porous carbon to form a silicon-carbon composite, in which, in the step of forming the silicon-carbon composite by depositing silicon onto the porous carbon, the amount of silicon is about 40 parts by weight or more and about 60 parts by weight or less based on 100 parts by weight of the silicon-carbon composite, the modulus (A) of the silicon-carbon composite is about 15 GPa to about 25 GPa, and the hardness (B) of the silicon-carbon composite is about 2,500 MPa to about 5,000 MPa.

Yet another embodiment of the present disclosure provides a negative electrode composition for a lithium secondary battery, including the negative electrode active material according to the present disclosure; a negative electrode conductive material; and negative electrode binder.

Still another embodiment of the present disclosure provides a negative electrode for a lithium secondary battery, including: a negative electrode current collector layer, and a negative electrode active material layer provided on one or both sides of the negative electrode current collector layer, in which the negative electrode active material layer includes the negative electrode composition according to the present disclosure or a cured product thereof.

Still yet another embodiment of the present disclosure provides a lithium secondary battery including a positive electrode, the negative electrode for a lithium secondary battery according to the present disclosure, a separator interposed between the positive electrode and the negative electrode, and an electrolyte.

In the case of the negative electrode active material for a lithium secondary battery according to an embodiment of the present disclosure, the negative electrode active material includes a silicon-carbon composite including silicon deposited on porous carbon. In the case of the silicon-carbon composite according to an embodiment of the present disclosure, silicon is densely deposited onto the porous carbon during the deposition process, resulting in a uniform surface.

The negative electrode for a lithium secondary battery undergoes a process in which a negative electrode slurry is applied onto a negative electrode current collector layer and subsequently rolled during manufacture. At this time, due to the rolling pressure, the composite-type negative electrode active material may break, resulting in silicon being exposed on the surface.

In the case of the silicon-carbon composite according to the present disclosure, by controlling the physical properties of the porous carbon precursor and adjusting the amount of silicon deposited, more uniform and dense deposition of silicon is achieved. The silicon-carbon composite manufactured under these conditions exhibits improved particle strength, thereby enhancing the capacity characteristics of the battery and reinforcing its lifespan characteristics.

The negative electrode for a lithium secondary battery including the silicon-carbon composite according to the present disclosure ensures excellent capacity characteristics while minimizing side reactions on the surface of the active material, thereby improving resistance, and enhancing lifespan performance against volume expansion.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a flowchart illustrating a process for manufacturing a silicon-carbon composite according to an embodiment of the present disclosure.

FIG. 2 is a view illustrating a method of measuring the physical properties according to the present disclosure using a nanoindenter (Top).

FIG. 3 is a diagram illustrating a stacked structure of a negative electrode for a lithium secondary battery according to an embodiment of the present disclosure.

FIG. 4 is a diagram illustrating a stacked structure of a lithium secondary battery according to an embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Before describing the present disclosure, some terms are first defined.

Through the specification, when a part is said to “include” a component, this does not exclude other components, but rather includes other components, unless otherwise specifically stated.

As used herein, “p to q” means a range of “p or more and q or less.”

As used herein, the “specific surface area” is measured by the Brunauer-Emmett-Teller (BET) method, and is calculated from the nitrogen gas adsorption amount at liquid nitrogen temperature (77 K) using, for example, BELSORP-mini II manufactured by BEL Japan. For example, in the present disclosure, the BET specific surface area may mean the specific surface area measured by the above-mentioned measurement method.

As used herein, “Dn” represents particle size distribution, and means a particle size at the n % point of the cumulative distribution of the number of particles according to particle size. For example, D50 is a particle size (average particle size) at the 50% point of the cumulative distribution of the number of particles according to particle size, D90 is a particle size at the 90% point of the cumulative distribution of the number of particles according to particle size, and D10 is a particle size at the 10% point of the cumulative distribution of the number of particles according to particle size. Meanwhile, the average particle size may be measured using a laser diffraction method. For example, powder to be measured is dispersed in a dispersion medium and introduced into a commercially available laser diffraction particle size measurement device (e.g., Microtrac S3500) to measure the difference in diffraction pattern according to particle size when the particles pass through the laser beam, thereby calculating the particle size distribution.

In an embodiment of the present disclosure, a particle size or particle diameter may mean an average diameter or a representative diameter of each grain forming the metal powder.

As used herein, when a polymer contains a certain monomer as a monomer unit, it means that the monomer participates in a polymerization reaction and is contained as a repeating unit in the polymer. In the present specification, when a polymer is said to contain a monomer, it is to be construed as the same as that the polymer contains a monomer as a monomer unit.

As used herein, the term “polymer” is understood to be used in a broad sense to include copolymers unless specified as “homopolymer.”

As used herein, the weight average molecular weight (Mw) and number average molecular weight (Mn) are polystyrene-converted molecular weights measured by gel permeation chromatography (GPC) using monodisperse polystyrene polymers (standard samples) of various degrees of polymerization commercially available for molecular weight measurement as standard materials. In the present specification, unless otherwise specified, molecular weight means weight average molecular weight.

As used herein, the terms “about,” “approximately,” and “substantially” refer to a range of, or approximation to a numerical value or degree, taking into account inherent manufacturing and material tolerances (e.g., ±5%).

In general, a secondary battery is constituted by a positive electrode, a negative electrode, an electrolyte, and a separator. The negative electrode includes a negative electrode active material that inserts and releases lithium ions from the positive electrode, and a silicon-based active material having a large discharge capacity may be used as the negative electrode active material.

Recently, as the demand for high-density energy batteries increases, research is actively being conducted on methods to increase the capacity by using silicon compounds, such as Si/C or SiOₓ, which have a capacity about 10 times greater than that of graphite-based materials, as the negative electrode active material. However, silicon-based compounds, which are high-capacity materials, have a large capacity compared to conventionally used graphite, but suffer from the problem that they rapidly expand in volume during charging process, which causes the conductive path to be cut off, and degrades the battery characteristics.

In order to solve such problems when silicon-based compounds are used as negative electrode active materials, various methods are being studied, such as methods for controlling the operating potential, methods for additionally coating a thin film on the surface of the active material layer, methods for controlling the particle size of the silicon-based compound to suppress the volume expansion itself, or methods for preventing the conductive path from being disconnected. However, since the above-mentioned methods may rather lower the performance of the battery, there are limitations in their application, and there are still limitations in the commercialization of negative electrode batteries with a high content of silicon-based compounds.

In recent years, research has been conducted on silicon-carbon composites among silicon-based active materials, in order to secure characteristics such as high energy density and fast charging. In manufacturing a negative electrode, a slurry including a negative electrode active material is applied to a negative electrode current collector layer and then subjected to rolling. However, in the case of silicon-carbon composites, since silicon and carbon are present in a composite state, the composite is easily fractured during the rolling process, thereby exposing silicon, which is vulnerable to the moisture, to the moisture. As a result, there arises a problem in that the lifetime characteristics are degraded.

In view of these issues, the present disclosure provides a technology capable of preventing or suppressing the conduction path from being damaged due to the volume expansion of the silicon-carbon composite, even when the silicon-carbon composite is used as the negative electrode active material.

Hereinafter, embodiments of the present disclosure are described in detail with reference to the drawings to enable one of ordinary skill in the art to which the present disclosure belongs, to easily practice the present disclosure. However, the present disclosure may be implemented in various different forms and is not limited to the following description.

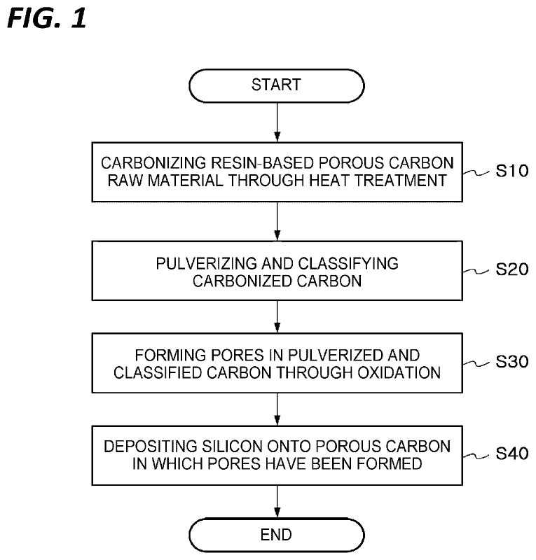

FIG. 1 is a flowchart illustrating a process for manufacturing a silicon-carbon composite according to an embodiment of the present disclosure.

Referring to FIG. 1, a process for manufacturing a silicon-carbon (Si/C) composite according to an embodiment of the present disclosure includes (S10) a step of carbonizing a resin-based raw material under appropriate conditions through heat treatment; (S20) a step of pulverizing and classifying the powder obtained through the carbonization process; (S30) a step of forming and expanding pores by oxidizing the pulverized and classified carbon; and (S40) a step of depositing silicon onto the porous carbon having the formed pores.

In the meantime, the silicon-carbon composite prepared through the above steps is used to produce a negative electrode active material for a lithium secondary battery, and a negative electrode is manufactured by forming a negative electrode active material layer on a negative electrode current collector using the negative electrode active material.

In the meantime, through the above process, the silicon-carbon composite thus manufactured is evaluated for its physical properties by measuring the modulus and hardness of the material. The modulus represents the stiffness of the material, indicating its resistance to deformation under an external force, while the hardness represents the resistance of the material surface to external scratching or indentation. For example, the modulus refers to the overall deformation resistance capability of the material, whereas the hardness refers to the resistance capability of the material surface against scratching or denting.

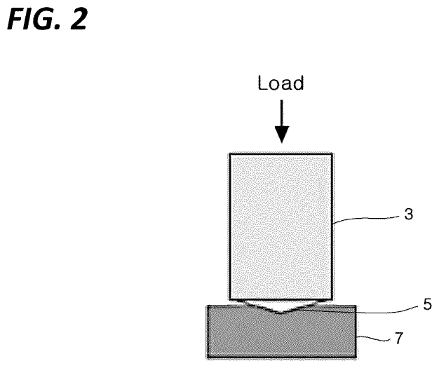

Referring to FIG. 2, according to an embodiment of the present disclosure, the modulus and hardness values may be measured by preparing an epoxy mold 7 including the silicon-carbon composite and using a nanoindenter 3. The nanoindenter 3 is an apparatus that measures mechanical properties such as hardness, elastic modulus, and viscoelasticity of a material by applying a minute force to the material using a nanoscale indenter tip 5 and measuring the resulting load and depth variations. The preparation of the epoxy mold 7 is described in greater detail below.

An embodiment of the present disclosure provides a negative electrode active material including a silicon-carbon composite having a modulus (A) of about 15 GPa to about 25 GPa and a hardness (B) of about 2,500 MPa to about 5,000 MPa.

The present disclosure improves capacity characteristics and achieves high energy density by including a silicon-carbon composite as a negative electrode active material, as compared to cases where only carbon-based active materials are used, and also enhances rapid charging performance.

In the present disclosure, the silicon-carbon composite refers to a composite of Si and C, which is distinct from silicon carbide (SiC).

In the present disclosure, the silicon-carbon composite may include any conventionally manufactured silicon-carbon composite without limitation. For example, the composite may include a deposition-type or pulverization-type silicon-carbon composite.

In the present disclosure, the silicon-based active material may be a silicon-carbon composite including porous carbon and silicon deposited on the porous carbon.

The silicon-carbon composite may be formed by compounding silicon and graphite, and may form a structure in which a core compounded with silicon and graphite is surrounded by graphene or amorphous carbon. In the silicon-carbon composite, the silicon may be nano-silicon. For example, the nano-silicon may be silicon having a size in the range of about 1 nm to 999 nm.

In the present disclosure, in order to improve the measurement accuracy of the modulus of the silicon-carbon composite in powder form, a molded specimen may be prepared using epoxy for measurement.

For example, an epoxy resin and an epoxy curing agent are mixed at a ratio of 1:1, placed into a mold, and cured for 24 hours to form a first layer. Subsequently, the epoxy resin and the epoxy curing agent are mixed again at a ratio of 1:1, and 1 g of the silicon-carbon composite is added and uniformly mixed. The mixture is then poured and cured on the first layer to prepare an epoxy mold sample. After polishing the surface of the mold, 1 g of the silicon-carbon composite to be measured is sampled, and the modulus is measured in the depth direction from the cross-section using a nanoindenter.

In the present disclosure, the hardness value may be expressed as indentation hardness. Similar to the modulus, the hardness may be measured by preparing an epoxy mold sample, sampling 1 g of the silicon-carbon composite to be measured, and measuring in the depth direction from the cross-section using a nanoindenter. At this time, the indentation hardness (Hardness) may be measured according to Formula 1-A:

$$Hardness = Pmax / A \qquad [ Formula 1 - A ]$$

In Formula 1-A,
“Pmax” represents the maximum load, and
“A” represents the projected contact area.

When indenting the particles using a nanoindenter, the surface of the material does not make perfect contact with the indenter tip, and some portions remain uncontacted. Therefore, a difference arises between the total penetration depth and the actual contact depth. The hardness value may be derived from a corrected value that compensates for this difference.

In an embodiment of the present disclosure, the modulus (A) of the silicon-carbon composite may be about 15 GPa to about 25 GPa.

In another embodiment, the modulus (A) of the silicon-carbon composite may be about 15 GPa to about 25 GPa, for example about 16 GPa to about 24 GPa, or about 17 GPa to about 23 GPa.

In the present disclosure, the hardness (B) of the silicon-carbon composite may be about 2,500 MPa to about 5,000 MPa, for example, about 3,000 MPa to about 4,900 MPa, or about 3,500 MPa to about 4,700 MPa.

In the present disclosure, the modulus (A) and the hardness (B) of the silicon-carbon composite may satisfy Formula 1:

$$0.1 \leq {B}^{3} / {A}^{2} \qquad [ Formula 1 ]$$

In the present disclosure, Formula 1 may be 0.1≤B³/A², for example, 0.15≤B³/A², or 0.16≤B³/A², and may be B³/A²≤0.45, B³/A²≤0.44, or B³/A²≤0.43.

In the present disclosure, Formula 1 serves as an indicator representing the degree of resistance of the silicon-carbon composite to particle fracture (e.g., a plastic deformation) and is used for interpreting analytical results in nanoindenter analysis.

In this range, the B³/A² value of epoxy alone is about 0.00046, while the B³/A² value of the porous carbon, which is the raw material of the silicon-carbon composite, is in a range of about 0.01 to about 0.03. The silicon-carbon composite, in which silicon is deposited on the porous carbon, exhibits a larger value. By satisfying the range of Formula 1, the composite exhibits reduced plastic deformation of the negative electrode active material during the slurry rolling process, thereby providing an advantage of suppressing lifespan degradation and problems caused by silicon exposure.

In the silicon-carbon composite according to the present disclosure, the modulus and hardness values fall within the above ranges and satisfy Formula 1, resulting in suitable mechanical strength of the composite that prevents particle fracture during rolling. Furthermore, although excessive strength may hinder the formation of conductive pathways, the composite satisfying the range of the present disclosure also provides improved electrical conductivity within the electrode.

In the present disclosure, the silicon content in the silicon-carbon composite may be about 40 parts by weight or more and about 60 parts by weight or less, based on 100 parts by weight of the silicon-carbon composite, for example about 43 parts by weight or more and about 60 parts by weight or less, or about 45 parts by weight or more and about 55 parts by weight or less.

When the deposition amount of silicon on the porous carbon satisfies the above range and the physical properties of the porous carbon, which will be described later, are adjusted, the modulus and hardness values described above may be achieved, thereby improving the capacity characteristics and also ensuring lifespan characteristics.

In the present disclosure, the silicon-carbon composite further includes a carbon coating layer. The composition and the manufacturing method of the carbon coating layer may be those conventionally known in the art.

In the present disclosure, the negative electrode active material may further include a carbon-based active material.

In the present disclosure, the carbon-based active material may include graphite, and the graphite may include natural graphite and artificial graphite.

In the present disclosure, the natural graphite may have an average particle diameter (D50) of about 5 μm to about 20 μm, and the artificial graphite may have an average particle diameter (D50) of about 5 μm to about 20 μm.

In another embodiment, the average particle diameter (D50) of the natural graphite may be about 5 μm to 20 μm, for example, about 7 μm to 18 μm, or about 9 μm to 15 μm.

In another embodiment, the average particle diameter (D50) of the artificial graphite may be about 5 μm to 20 μm, for example, about 8 μm to 18 μm, or about 10 μm to 16 μm.

In the present disclosure, the weight ratio of artificial graphite to natural graphite may be about 60:40 to 80:20 based on 100 parts by weight of the carbon-based active material.

In another embodiment, the weight ratio of artificial graphite to natural graphite may be about 60:40 to 80:20, for example, about 65:35 to 78:22, or about 70:30 to 75:25 based on 100 parts by weight of the carbon-based active material.

In the case of graphite, both artificial graphite and natural graphite may be included. It has been confirmed that artificial graphite exhibits superior cell characteristics compared with natural graphite, so the use of natural graphite has been reduced and the use amount of artificial graphite has been increased. However, from the viewpoint of cost, artificial graphite requires coking and graphitization processes, which result in high processing costs. Accordingly, when the above ranges are satisfied, both the cost issue and the improvement of cell characteristics may be achieved.

In the present disclosure, the negative electrode active material may include the silicon-carbon composite in an amount of about 80 parts by weight or less, based on 100 parts by weight of the negative electrode active material.

In another embodiment, the negative electrode active material may include the silicon-carbon composite in an amount of about 80 parts by weight or less, for example about 75 parts by weight or less, or about 70 parts by weight or less, about 1 part by weight or more, about 5 parts by weight or more, or about 10 parts by weight or more, based on 100 parts by weight of the negative electrode active material.

By including the negative electrode active material within the above-described range, it is possible to secure the capacity characteristics and energy density of the negative electrode. For example, as the content of the silicon-carbon composite increases, the energy density may be improved, but the cycle characteristics deteriorate due to severe volume expansion. When the content of the silicon-carbon composite decreases, it is not possible to secure high energy density and fast-charging performance. Therefore, when the above-described content is used, both high energy density and improved fast-charging performance may be achieved.

Meanwhile, the average particle diameter (D50 particle size) of the silicon-carbon composite of the present disclosure is about 1 μm or more and 10 μm or less, for example, about 2 μm to 8 μm, or may be about 3 μm to 8 μm. When the average particle diameter is within the above range, the specific surface area of the particles is within an appropriate range, so that the viscosity of the negative electrode slurry is formed within an appropriate range. Accordingly, the particles constituting the negative electrode slurry are smoothly dispersed. In addition, when the size of the silicon-carbon composite is greater than the lower limit range, the contact area between the silicon-carbon composite and the conductive material is excellent due to the composite made up of the conductive material and the binder in the negative electrode slurry, so that the possibility of the conductive network being sustained increases, thereby increasing the capacity retention rate. Meanwhile, when the average particle diameter satisfies the above range, excessively large silicon particles are excluded, so that the surface of the negative electrode is formed smoothly, and thus the phenomenon of uneven current density during charge and discharge may be suppressed.

In an embodiment of the present disclosure, the silicon-carbon composite generally has a characteristic BET surface area. According to an embodiment, the BET surface area of the silicon-carbon composite is about 0.01 m²/g to 150 m²/g, about 0.1 m²/g to 100 m²/g, about 0.2 m²/g to 80 m²/g, or about 0.2 m²/g to 18 m²/g. The BET surface area is measured (using nitrogen) according to DIN 66131.

In an embodiment of the present disclosure, the silicon of the silicon-carbon composite may be present in crystalline or amorphous form, and the silicon may be, for example, spherical or fragmentary particles. Alternatively, the silicon may also have a fibrous structure or may be present in the form of a silicon-containing film or coating.

In an embodiment of the present disclosure, the silicon-carbon composite may have a non-spherical shape, and its circularity is, for example, about 0.9 or less, about 0.7 to 0.9, about 0.8 to 0.9, or about 0.85 to 0.9.

In the present disclosure, the circularity is determined by Equation 1-B below, where A is an area, and P is a boundary line.

$$4 π A / {P}^{2} \qquad [ Formula 1 - B ]$$

In an embodiment of the present disclosure, a negative electrode composition for a lithium secondary battery is provided, which includes the negative electrode active material for a lithium secondary battery as described above; a negative electrode conductive material; and negative electrode binder.

In an embodiment of the present disclosure, a negative electrode composition is provided, in which the negative electrode active material is about 40 parts by weight or more based on 100 parts by weight of the negative electrode composition.

In another embodiment, the negative electrode active material may be included in an amount of about 40 parts by weight or more, for example, about 60 parts by weight or more, about 65 parts by weight or more, or about 70 parts by weight or more, and may be about 99 parts by weight or less, for example, about 98 parts by weight or less, or about 96 parts by weight or less, based on 100 parts by weight of the negative electrode composition.

The negative electrode composition according to the present application uses a negative electrode active material that satisfies a specific pore distribution that suppresses volume expansion and side reactions during charging and discharging even when the silicon-carbon composite having a significantly high capacity is used within the above range, so that the performance of the negative electrode is not deteriorated even within the above range, and the output characteristics during charge and discharge are excellent.

Conventionally, it has been common to use only graphite compounds as negative electrode active materials, but recently, as the demand for high-capacity batteries has increased, attempts to mix and use silicon-based active materials to increase a capacity have been increasing. However, in the case of silicon-based active materials, even when the characteristics of the silicon-based active material itself are adjusted as described above, there may be some problems that the volume rapidly expands during the charging/discharging process, which may damage the conductive path formed within the negative electrode active material layer.

Accordingly, in an embodiment of the present disclosure, the negative electrode conductive material may include at least one selected from particulate conductive material, flake-type conductive material, and fibrous conductive material.

In an embodiment of the present disclosure, the particulate conductive material may be used to improve conductivity of the negative electrode, and means a particulate or spherical conductive material having conductivity without causing a chemical change. For example, the particulate conductive material may include at least one selected from natural graphite, artificial graphite, carbon black, acetylene black, Ketjen black, channel black, furnace black, lamp black, thermal black, conductive fibers, fluorocarbons, aluminum powder, nickel powder, zinc oxide, potassium titanate, titanium oxide, and polyphenylene derivatives, for example, may include carbon black in view of its ability to implement high conductivity and excellent dispersibility.

In an embodiment of the present disclosure, the particulate conductive material may have a BET surface area of about 40 m²/g or more and 70 m²/g or less, for example, about 45 m²/g or more and 65 m²/g or less, or about 50 m²/g or more and 60 m²/g or less.

In an embodiment of the present disclosure, the particulate conductive material may satisfy a functional group (volatile matter) content of about 0.01% or more and 1% or less, for example, 0.01% or more and 0.3% or less, or about 0.01% or more and 0.1% or less.

When the functional group content of the particulate conductive material satisfies the above range, a functional group present on the surface of the particulate conductive material, so that when water is used as a solvent, the particulate conductive material may be smoothly dispersed in the solvent. In the present disclosure, by using a specific silicon-based active material, the functional group content of the particulate conductive material may be reduced, thereby having an excellent effect in improving dispersibility.

In an embodiment of the present disclosure, a particulate conductive material having a functional group content within the above range is included together with a silicon-based active material, and the control of the functional group content may be controlled according to the degree of heat treatment of the particulate conductive material.

In an embodiment of the present disclosure, the particle size of the particulate conductive material may be about 10 nm to 100 nm, for example, about 20 nm to 90 nm, or about 20 nm to 60 nm.

In an embodiment of the present disclosure, the conductive material may include a flake-type conductive material.

The flake-type conductive material may play a role in improving conductivity by increasing planar contact between silicon particles in the negative electrode, and at the same time suppressing disconnection of the conductive path due to volume expansion. The flake-type conductive material may be expressed as a plate-type conductive material or a bulk conductive material.

In an embodiment of the present disclosure, the flake-type conductive material may include at least one selected from plate-type graphite, graphene, graphene oxide, and graphite flakes, and in an embodiment, the flake-type conductive material may be plate-type graphite.

In an embodiment of the present disclosure, the average particle diameter (D50) of the flake-type conductive agent may be about 2 μm to 7 μm, for example, about 3 μm to 6 μm, or about 3.5 μm to 5 μm. When the above range is satisfied, the particle size is sufficient to facilitate dispersion without causing an excessive increase in viscosity of the negative electrode slurry. Therefore, the dispersion effect is excellent when dispersion is performed using the same equipment and time.

In an embodiment of the present disclosure, the surface-shaped conductive material may be a high-specific surface area surface-shaped conductive material having a high BET surface area; or a low-specific surface area surface-shaped conductive material.

In an embodiment of the present disclosure, a high-specific surface area surface-shaped conductive material or a low-specific surface area surface-shaped conductive material may be used without any limitation as the surface-shaped conductive material. However, since the surface-shaped conductive material according to the present disclosure may be affected to some extent by dispersion influence on electrode performance, a low-specific surface area surface-shape conductive material that does not cause dispersion problems may be used.

In an embodiment of the present disclosure, the flake-type conductive material may have a BET specific surface area of about 1 m²/g or more.

In another embodiment, the flake-type conductive material may have a BET specific surface area of about 1 m²/g or more and 500 m²/g or less, for example, about 5 m²/g or more and 300 m²/g or less, or about 5 m²/g or more and 250 m²/g or less.

The flake-type conductive material according to the present disclosure may use a high-specific surface area flake-type conductive material or a low-specific surface area flake-type conductive material.

In another embodiment, the flake-type conductive material is a high-specific surface area surface-shaped conductive material, and may have a BET surface area in a range of about 50 m²/g to 500 m²/g, for example, about 80 m²/g to 300 m²/g, or about 100 m²/g to 300 m²/g.

In yet another embodiment, the flake-type conductive material is a low-specific surface area surface-shaped conductive material, and may have a BET surface area in a range of about 1 m²/g to 40 m²/g, for example, about 5 m²/g to 30 m²/g, or about 5 m²/g to 25 m²/g.

Other conductive materials may include fibrous conductive materials such as carbon nanotubes. The carbon nanotubes may be bundle-type carbon nanotubes. The bundle-type carbon nanotubes may include a plurality of carbon nanotube units. Here, unless otherwise stated, the term “bundle-type” refers to a secondary shape in the form of a bundle or rope in which a plurality of carbon nanotube units are arranged in a substantially same orientation in a parallel manner or entangled with the longitudinal axes of the carbon nanotube units. The carbon nanotube units have a cylindrical shape of a graphite sheet with a nano-sized diameter and an sp² bonding structure. At this time, depending on the angle and structure at which the graphite sheet is rolled, the characteristics of a conductor or a semiconductor may be exhibited. The bundled-type carbon nanotubes may be uniformly dispersed during the manufacture of a negative electrode compared to entangled type carbon nanotubes, and may smoothly form a conductive network within the negative electrode, thereby improving the conductivity of the negative electrode.

In the present disclosure, a negative electrode composition is provided in which the negative electrode conductive material is about 20 parts by weight or less, based on 100 parts by weight of the negative electrode composition.

In another embodiment, the negative electrode conductive material is about 20 parts by weight or less, about 17 parts by weight or less, or about 15 parts by weight or less, and is about 0.01 parts by weight or more or about 0.02 parts by weight or more, based on 100 parts by weight of the negative electrode composition.

The negative electrode conductive material according to the present disclosure has a completely separate composition from the positive electrode conductive material applied to the positive electrode. For example, the negative electrode conductive material according to the present disclosure plays a role of holding the contact point between silicon-based active materials, which greatly expand the volume of the electrode due to charging and discharging, and the positive electrode conductive material plays a role of providing some conductivity while acting as a buffer when rolled, and is completely different in composition and role from the negative electrode conductive material of the present disclosure.

In addition, the negative electrode conductive material according to the present disclosure is applied to a silicon-based active material, and has a composition that is different from that of a conductive material applied to a graphite-based active material. For example, the conductive material used in an electrode having a graphite-based active material simply has smaller particles compared to the active material, and thus has the characteristics of improving output characteristics and imparting some conductivity, and is completely different in composition and role from the negative electrode conductive material applied together with a silicon-based active material, as in the present disclosure.

In an embodiment of the present disclosure, the flake-type conductive material used as the negative electrode conductive material has a structure and a role different from those of the carbon-based active material generally used as the negative electrode active material. For example, the carbon-based active material used as the negative electrode active material may be artificial graphite or natural graphite, and refers to a material processed into a spherical or dot-shaped form to facilitate the storage and release of lithium ions.

In the meantime, the flake-type conductive material used as the negative electrode conductive material is a material having a planar or plate-like shape, and may be expressed as plate-type graphite. For example, the flake-type conductive material refers to a material included to maintain a conductive path within the negative electrode active material layer, and refers to a material that secures a planar conductive path within the negative electrode active material layer rather than a material that plays a role in storing and releasing lithium.

In the present disclosure, the use of plate-type graphite as a conductive material means that it is processed into a planar or plate-shaped form, and used as a material that secures a conductive path rather than a role of storing or releasing lithium. In this case, the negative electrode active material included together has high capacity characteristics for lithium storage and release, and plays a role of storing and releasing all lithium ions transferred from the positive electrode.

In addition, in the present disclosure, the use of a carbon-based active material as an active material means that it is processed into a particulate or spherical shape and used as a material that stores or releases lithium.

In an embodiment of the present disclosure, the carbon-based active material, which is artificial graphite or natural graphite, may have a dot-like shape and a BET surface area satisfying a range of about 0.1 m²/g or more and 4.5 m²/g or less. In addition, the plate-like graphite, which is a flake-type conductive material, may have a BET surface area of about 5 m²/g or more in a flake shape.

In an embodiment of the present disclosure, the negative electrode binder may include at least one selected from polyvinylidene fluoride-hexafluoropropylene copolymer (PVDF-co-HFP), polyvinylidene fluoride, polyacrylonitrile, polymethylmethacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, ethylene-propylene-diene monomer (EPDM), sulfonated EPDM, styrene butadiene rubber (SBR), fluororubber, poly acrylic acid, and materials in which hydrogens thereof are substituted with Li, Na or Ca, and may also include various copolymers thereof.

The negative electrode binder according to an embodiment of the present disclosure serves to hold the active material and the conductive material in order to suppress distortion and structural deformation of the negative electrode structure in volume expansion and relaxation of the silicon-based active material, and any general binder may be applied when the above role is satisfied. For example, a water-based binder may be used or a PAM-based binder may be used.

In an embodiment of the present disclosure, the negative electrode binder may be about 30 parts by weight or less, for example, about 25 parts by weight or less, or about 20 parts by weight or less, based on 100 parts by weight of the negative electrode composition, and may be about 5 parts by weight or more, or about 10 parts by weight or more.

In an embodiment of the present disclosure, a method for manufacturing a negative electrode active material is provided, which includes: preparing porous carbon; and depositing silicon onto the porous carbon to form a silicon-carbon composite. In the step of forming the silicon-carbon composite by depositing silicon onto the porous carbon, the amount of silicon is about 40 parts by weight or more and about 60 parts by weight or less based on 100 parts by weight of the silicon-carbon composite, the modulus (A) of the silicon-carbon composite is about 15 GPa to about 25 GPa, and the hardness (B) of the silicon-carbon composite is about 2,500 MPa to about 5,000 MPa.

In the present disclosure, the porous carbon may have a ratio of first pores having a diameter of less than about 2 nm, as measured by nitrogen adsorption, of about 90% or more, and a ratio of second pores having a diameter of about 2 nm or more and about 50 nm or less, as measured by nitrogen adsorption, of about 10% or less.

The present disclosure achieves the aforementioned physical properties by appropriately selecting the conditions of the porous carbon as described above. For example, in the manufacture of the silicon-carbon composite, when the micropore volume of the porous carbon is about 90% or greater and porous carbon made of resin rather than biomass is used, the rigidity of the resulting silicon-carbon composite is enhanced. Accordingly, the above-described physical properties are satisfied, and thus, the composite has characteristics that enhance the lifespan characteristics of the secondary battery.

In addition, the porous carbon provides a method of manufacturing a negative electrode active material, in which the circularity is about 0.7 to 0.9 as defined by Formula 1:

$$4 π A / {P}^{2} \qquad [ Formula 1 ]$$

In Formula 1, “A” is an area, and “P” is a perimeter.

When the physical properties of the porous carbon are controlled as described above, the mechanical rigidity is enhanced, and by using porous carbon satisfying the physical properties, the density and deposition uniformity of silicon may be improved during deposition.

According to an embodiment, the present disclosure provides a negative electrode for a lithium secondary battery, including: a negative electrode current collector layer, and a negative electrode active material layer provided on one or both sides of the negative electrode current collector layer, in which the negative electrode active material layer includes the negative electrode composition according to the present disclosure or a cured product thereof.

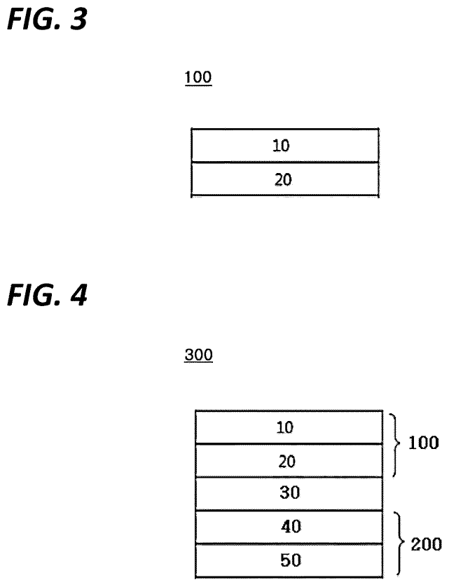

FIG. 3 is a diagram illustrating a stacked structure of a negative electrode for a lithium secondary battery according to an embodiment of the present disclosure.

Referring to FIG. 3, a negative electrode 100 for a lithium secondary battery includes a negative electrode active material layer 20 on one surface of a negative electrode current collector layer 10. FIG. 3 illustrates that the negative electrode active material layer 20 is formed on one surface of the negative electrode current collector layer 10, but, the negative electrode active material layer 20 may also be formed on both surfaces of the negative electrode current collector layer 10.

In an embodiment of the present disclosure, the negative electrode 100 for the lithium secondary battery may be formed by applying and drying a negative electrode slurry containing the negative electrode composition to one side or both sides of the negative electrode current collector layer 10.

At this time, the negative electrode slurry may include the negative electrode composition and a slurry solvent.

In an embodiment of the present disclosure, the solid content of the negative electrode slurry may satisfy a range of about 5% to 40%.

In another embodiment, the solid content of the negative electrode slurry may satisfy a range of about 5% to 40%, for example, about 7% to 35%, or about 10% to 30%.

The solid content of the negative electrode slurry may refer to the content of the negative electrode composition included in the negative electrode slurry, and may be expressed as the content of the negative electrode composition based on 100 parts by weight of the negative electrode slurry.

When the solid content of the negative electrode slurry is within the above range, the viscosity during formation of the negative electrode active material layer is appropriate, minimizing particle agglomeration of the negative electrode composition and allowing the negative electrode active material layer to be efficiently formed.

In an embodiment of the present disclosure, the slurry solvent may be used without limitation as long as it is capable of dissolving the negative electrode composition, and examples thereof may include water or NMP (N-methyl-2-pyrrolidone).

In an embodiment of the present disclosure, the negative electrode current collector layer 10 generally has a thickness of about 1 μm to 100 μm. The negative electrode current collector layer 10 is not particularly limited as long as it has high conductivity without causing chemical changes in the battery, and examples thereof include copper, stainless steel, aluminum, nickel, titanium, calcined carbon, copper or stainless steel surface-treated with carbon, nickel, titanium, or silver, and aluminum-cadmium alloy. In addition, the negative electrode collector layer may have fine unevenness formed on the surface to strengthen the bonding strength of the negative electrode active material, and may be used in various forms such as a film, sheet, foil, net, porous body, foam, and non-woven fabric.

In an embodiment of the present disclosure, a negative electrode 100 for a lithium secondary battery is provided, in which the negative electrode current collector layer 10 has a thickness of about 1 μm or more to about 100 μm or less, and the negative electrode active material layer 20 has a thickness of about 5 μm or more to about 500 μm or less.

However, the thickness may be variously modified depending on the type and purpose of the negative electrode 10 used and is not limited thereto.

In an embodiment of the present disclosure, the porosity of the negative electrode active material layer 20 may be about 10% or more and 60% or less.

In another embodiment, the porosity of the negative electrode active material layer 20 may be about 10% or more and 60% or less, for example, about 20% or more and 50% or less, or about 25% or more and 45% or less.

The porosity varies depending on the composition and content of the silicon-based active material, the conductive material, and the binder included in the negative electrode active material layer 20. By including the silicon-based active material and the conductive material according to the present disclosure in a specific composition and contents thereof, the above range is satisfied, and accordingly, the electric conductivity and resistance of the electrode have an appropriate range.

In an embodiment of the present disclosure, a lithium secondary battery is provided, which includes a positive electrode, the negative electrode for a lithium secondary battery according to the present disclosure, a separator interposed between the positive electrode and the negative electrode, and an electrolyte.

FIG. 4 illustrates a stacked structure of a secondary battery 300 according to an embodiment of the present disclosure. For example, the negative electrode 100 for a lithium secondary battery includes the negative active material layer 20 on one side of a negative current collector layer 10, and a positive electrode 200 for a lithium secondary battery includes a positive active material layer 40 on one side of a positive current collector layer 50. In addition, the lithium secondary battery negative electrode 100 and the lithium secondary battery positive electrode 200 are formed in a stacked structure with a separator 30 interposed therebetween.

The lithium secondary battery 300 according to an embodiment of the present disclosure may include the negative electrode 100 for a lithium secondary battery as described above. The lithium secondary battery 300 may include the negative electrode 100, a positive electrode 200, a separator 30 interposed between the positive electrode 200 and the negative electrode 100, and an electrolyte (not illustrated). The negative electrode 100 is the same as the above-described negative electrode 100. The negative electrode 100 has already been described, and thus, further description is omitted.

The positive electrode 200 may include a positive electrode current collector 50 and a positive electrode active material layer 40 formed on the positive electrode current collector 50 and including a positive electrode active material.

In the positive electrode 200, the positive electrode current collector 50 is not particularly limited as long as it has conductivity without causing chemical changes in the battery, and examples thereof include stainless steel, aluminum, nickel, titanium, calcined carbon, and aluminum or stainless steel surface-treated with carbon, nickel, titanium, or silver. The positive electrode current collector 50 may typically have a thickness of about 3 μm to 500 μm, and fine unevenness may be formed on the surface of the positive electrode current collector 50 to strengthen the bonding strength of the positive electrode active material. For example, the positive electrode collector may be used in various forms, such as a film, a sheet, a foil, a net, a porous body, a foam, a non-woven body, and the like.

The positive electrode active material may be a commonly used positive electrode active material. For example, the positive electrode active material may be a layered compound such as lithium cobalt oxide (LiCoO₂), lithium nickel oxide (LiNiO₂), or a compound substituted with one or more transition metals; lithium iron oxide such as LiFe₃O₄; lithium manganese oxide such as Li_{1+c}1Mn_{2-c1}O₄ (0≤c1≤0.33), LiMnO₃, LiMn₂O₃, and LiMnO₂; lithium copper oxide (Li₂CuO₂); vanadium oxide such as LiV₃O₈, V₂O₅, and Cu₂V₂O₇; Ni-site type lithium nickel oxide expressed by the chemical formula LiNi_{1-c2}M_{c2}O₂ (wherein, M is at least one selected from Co, Mn, Al, Cu, Fe, Mg, B, and Ga, and satisfies 0.01≤c2<0.3); a lithium manganese composite oxide represented by the chemical formula LiMn_{2-c3}M_{c3}O₂ (wherein, M is at least one selected from Co, Ni, Fe, Cr, Zn, and Ta, and satisfies 0.01≤c3≤0.1) or Li₂Mn₃MO₈ (wherein, M is at least one selected from Fe, Co, Ni, Cu, and Zn); LiMn₂O₄, in which a part of Li in the chemical formula is replaced with an alkaline earth metal ion; but the present disclosure is not limited thereto. The positive electrode may be Li-metal.

The positive electrode active material layer 40 may include a positive electrode conductive material and a positive electrode binder together with the positive electrode active material described above.

The positive electrode conductive material used to impart conductivity to the electrode may be any material that is electrically conductive without causing chemical changes in the battery to be constructed, without any particular limitation. Examples thereof include graphite such as natural graphite or artificial graphite; carbon-based materials such as carbon black, acetylene black, Ketjen black, channel black, furnace black, lamp black, thermal black, and carbon fiber; metal powder or metal fiber such as copper, nickel, aluminum, and silver; conductive whiskers such as zinc oxide and potassium titanate; conductive metal oxides such as titanium oxide; or conductive polymers such as polyphenylene derivatives, which may be used alone or in mixture of two or more thereof.

The positive electrode binder serves to improve the adhesion between positive electrode active material particles and the adhesive strength between the positive electrode active material and the positive electrode current collector. Examples thereof include polyvinylidene fluoride (PVDF), vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene polymer (EPDM), sulfonated-EPDM, styrene butadiene rubber (SBR), fluororubber, or various copolymers thereof, which may be used alone or in mixture of two or more thereof.

The separator 30 separates the negative electrode 100 and the positive electrode 200 and provides a migration passage for lithium ions. Any separator that is usually used as a separator in secondary batteries may be used without special restrictions, and any material having low resistance to ion migration in the electrolyte and excellent electrolyte moisture retention capacity may be selected. For example, the separator 30 to be used may be a porous polymer film, for example, a porous polymer film made of a polyolefin polymer such as ethylene homopolymer, propylene homopolymer, ethylene/butene copolymer, ethylene/hexene copolymer, and ethylene/methacrylate copolymer, or a laminated structure of two or more layers thereof. In addition, a conventional porous non-woven fabric, for example, a non-woven fabric made of high-melting-point glass fiber, polyethylene terephthalate fiber, and the like may be used as the separator 30. In addition, a coated separator containing a ceramic component or a polymer material may be used to secure heat resistance or mechanical strength, and may be selectively used in a single-layer or multi-layer structure.

The electrolyte used in the present disclosure may include, but is not limited to, an organic liquid electrolyte, an inorganic liquid electrolyte, a solid polymer electrolyte, a gel-type polymer electrolyte, a solid inorganic electrolyte, a molten inorganic electrolyte, and the like that may be used in the manufacture of a lithium secondary battery 300.

The electrolyte may include a non-aqueous organic solvent and a metal salt.

Examples of the non-aqueous organic solvent include an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxyethane, tetrahydrofuran, 2-methyl tetrahydrofuran, dimethyl sulfoxide, 1,3-dioxolan, formamide, dimethylformamide, dioxolan, acetonitrile, nitromethane, methyl formate, methyl acetate, triester phosphoric acid, trimethoxy methane, dioxolan derivatives, sulfolane, methyl sulfolane, 1,3-dimethyl-2-imidazolidinone, propylene carbonate derivatives, tetrahydrofuran derivatives, ethers, methyl propionate, and ethyl propionate.

Among the carbonate-based organic solvents, ethylene carbonate and propylene carbonate, which are cyclic carbonates, are high-viscosity organic solvents having high dielectric constants and exhibit effective dissociation capacity for lithium salts. When such cyclic carbonates are mixed in an appropriate ratio with low-viscosity, low-dielectric constant linear carbonates such as dimethyl carbonate and diethyl carbonate, an electrolyte having high electrical conductivity may be obtained.

The metal salt may be a lithium salt, and the lithium salt is a substance that is easily dissolved in the non-aqueous electrolyte. For example, an anion of the lithium salt may be at least one selected from F⁻, Cl⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

In addition to the electrolyte components, the electrolyte may further contain one or more additives, such as, for example, haloalkylene carbonate compounds such as difluoroethylene carbonate, pyridine, triethylphosphite, triethanolamine, cyclic ethers, ethylene diamine, n-glyme, hexaphosphoric acid triamide, nitrobenzene derivatives, sulfur, quinone imine dyes, N-substituted oxazolidinones, N,N-substituted imidazolidines, ethylene glycol dialkyl ethers, ammonium salts, pyrrole, 2-methoxy ethanol, or aluminum trichloride, for the purpose of improving the life characteristics of the battery, suppressing battery capacity decrease, and improving the discharge capacity of the battery.

an embodiment of the present disclosure provides a battery module including the lithium secondary battery 300 as a unit cell and a battery pack including the same. Since the battery module and the battery pack include the secondary battery 300 having high capacity, high rate characteristics, and cycle characteristics, they may be used as a power source for medium- and large-sized devices selected from electric vehicles, hybrid electric vehicles, plug-in hybrid electric vehicles, and power storage systems.

Hereinafter, examples are presented to assist in the understanding of the present disclosure, but the examples are merely illustrative of the disclosure, and it will be apparent to those skilled in the art that various modifications and alterations may be made within the spirit and scope of the present disclosure. It is, of course, understood that such modifications and alterations fall within the scope of the appended claims.

### Preparation Example

### Example 1

A resin-based raw material was placed in a tubular furnace, and under a condition without temperature elevation, the atmosphere inside the furnace was replaced with an inert gas by flowing argon at a rate of 50 ml/min to 200 ml/min for 2 hours. The temperature was then increased to 400° C. at a rate of 5° C./min, followed by heating under an argon atmosphere for 2 hours. Thereafter, the temperature was further increased to 900° C. at a rate of 5° C./min, and the carbonization process was performed by heating under an argon atmosphere for 2 hours.

After the reaction, the resulting powder was washed with ethanol two to three times.

The carbon-based particles dried at 100° C. for 12 hours or more were mixed with KOH at a weight ratio of 1:4 and heated at 700° C. for 4 hours under an argon atmosphere to expand the pores. Thereafter, the mixture was washed with distilled water and dried again at 100° C. for 12 hours or more. The porous carbon obtained through the activation process exhibited a ratio of first pores having a diameter of less than 2 nm, as measured by the nitrogen adsorption method, of 97%, a total pore volume of 0.87 m³/g, and a specific surface area of about 1,800 m²/g to 2,000 m²/g.

The porous carbon included a circularization step during the manufacturing process, and the circularization may be performed by a method selected from spray drying, rotary atomization, or a sol-gel process. Thereafter, a classification process was performed to remove fine particles smaller than 1 μm.

The classified porous carbon was placed in the hot zone of a CVD apparatus, and under a low-pressure condition of about 1 to 10 Torr, a mixed gas of SiH₄/H₂=5/95 was flowed at a rate of 50 to 210 ml/min at 600° C. for 6 hours to manufacture a silicon-carbon composite. Without removing the sample from the furnace, argon gas was continuously flowed while increasing the furnace temperature to 650° C. at a rate of 5° C./min. Then, a mixed gas of C₂H₂/H₂/Ar=10/50/40 was flowed at 200 ml/min and reacted for 3 hours to form a carbon coating layer on the surface, thereby manufacturing a silicon-carbon composite including a carbon layer on its surface.

### Example 2

The silicon-carbon composite was manufactured in the same manner as in Example 1, except that the porous carbon had a lower circularity due to the absence of a circularization process.

### Example 3

The silicon-carbon composite was manufactured in the same manner as in Example 1, except that biomass-based raw materials such as cellulose powder and coconut shells were used instead of resin-based raw materials, and a physical activation method was employed in which the carbon-based particles dried at 100° C. for 12 hours or more were heated at 700° C. for 3 hours under an argon atmosphere containing 10% to 20% CO₂ as a balance gas to expand the pores.

### Comparative Example 1

After biomass-based raw materials such as cellulose powder and coconut shells, rather than resin-based raw materials, were carbonized by heat treatment at 500° C. to 1,000° C. under an inert gas atmosphere as porous carbon precursors, the carbonized porous carbon was pulverized and classified. Then, the physical activation was performed by oxidizing the porous carbon using an oxidizing gas (steam, CO₂, O₂, etc.) to form pores. The resulting porous carbon was non-spherical porous carbon having a ratio of first pores with a diameter of less than 2 nm of 92% and a ratio of second pores with a diameter of 2 nm or more of 8%, as measured by a nitrogen adsorption method, and exhibited a total pore volume of about 0.75 m³/g and a specific surface area of about 1,600 m²/g.

Without undergoing a separate classification process to remove fine powder, the porous carbon was placed in the hot zone of a CVD apparatus, and a gas mixture of SiH₄/H₂=5/95 was flowed at a rate of 50 ml/min to 210 ml/min for 3 hours at 600° C. under a low-pressure condition of 1 Torr to 10 Torr to manufacture a silicon-carbon composite.

Without removing the composite from the furnace, only Ar gas was flowed while the furnace temperature was raised to 650° C. at a rate of 5° C./min. A mixed gas of C₂H₂/H₂/Ar=10/50/40 was then flowed at 200 ml/min for 1 hour to react and form a carbon layer on the surface of the silicon-carbon composite.

### Comparative Example 2

In the activation process of the porous carbon, carbon-based particles dried at 100° C. for 12 hours or more were heated at 700° C. for 5 hours under an argon atmosphere containing 10% to 20% CO₂ as a balance gas to expand the pores. The porous carbon prepared by this method exhibited a specific surface area of about 1,800 m²/g.

The silicon-carbon composite was manufactured in the same manner as in Comparative Example 1, except that, in the SiH₄ CVD process, the process time was 5 hours, and no carbon layer was formed on the surface.

### Comparative Example 3

The silicon-carbon composite was manufactured in the same manner as in Comparative Example 1, except that, in the SiH₄ CVD process, the process time was 1 hour, and the carbon layer forming process on the surface was carried out for 7 hours.

### Comparative Example 4

The silicon-carbon composite was manufactured in the same manner as in Comparative Example 1, except that, in the SiH₄ CVD process, the process time was 1 hour, and the carbon layer forming process on the surface was performed at 580° C. for 4 hours.

### Comparative Example 5

In Example 2, the carbon-based particles and KOH were mixed at a weight ratio of 1:5, the stirring time was increased by 30 minutes, and the mixture was heated at 700° C. for 7 hours for activation. Thereafter, the mixture was washed with distilled water and dried again at 100° C. for 12 hours or more.

The porous carbon obtained through the activation process exhibited a ratio of first pores having a diameter of less than 2 nm, as measured by the nitrogen adsorption method, of 97%, a total pore volume of 1.1 m³/g, and a specific surface area of about 2,200 m²/g to 2,200 m²/g.

The silicon-carbon composite was manufactured in the same manner as in Example 2, except that silicon deposition process was conducted for 5 hours, and the material no carbon layer was formed on the surface.

### Comparative Example 6

A porous carbon was manufactured in the same manner as in Example 1, except that the mixing of the carbon-based particles and KOH was carried out at a weight ratio of 1:3, and the porous carbon thus prepared had a total pore volume of 0.75 m³/g and a specific surface area in the range of 1,600 to 1,800 m²/g.

The classified porous carbon was placed in the hot zone of a CVD apparatus, and under a low-pressure condition of about 1 to 10 Torr, a mixed gas of SiH₄/H₂=5/95 was flowed at a rate of 50 to 210 ml/min at 600° C. for 4 hours to manufacture a silicon-carbon composite. Without removing the sample from the furnace, argon gas was continuously flowed while increasing the furnace temperature to 650° C. at a rate of 5° C./min. The manufacturing procedure was the same as in Example 1, except that a mixed gas of C₂H₂/H₂/Ar=10/50/40 was flowed at 200 ml/min for 7 hours to react and form a carbon layer on the surface.

### Comparative Example 7

### (1) Preparation of Magnesium-Containing Silicon Oxide

In Crucible 1, Si and SiO₂ were mixed at a molar ratio of 1:1 and heated to a sublimation temperature of 1.400° C. In Crucible 2, metallic magnesium was separately heated and evaporated at a temperature between 600° C. and 1,000° C.

Both crucibles were maintained under a reduced pressure of about 0.1 Torr. The vapor mixture containing Mg obtained from Crucibles 1 and 2 was reacted for 6 hours and then condensed into a solid phase in a vacuum region at 800° C.

The silicon-based active material prepared by the above method was pulverized for about 3 to 4 hours using a ball mill to produce particles having a D50 of about 6 μm. Subsequently, under an inert Ar atmosphere, methane (CH₄) was introduced into a CVD apparatus at a pressure of 10⁻¹ Torr and a flow rate of 1 L/min for about 5 hours to form a carbon layer on the surface of the silicon-based active material, thereby producing the magnesium-containing silicon oxide. The Mg content in the powder was analyzed by ICP-MS and was measured to be 8 wt %.

For the active materials prepared in Examples and Comparative Examples, the modulus and hardness values were measured, and the results are shown in Table 1 below.

TABLE 1

| | Modulus of | Hardness of | B³/A² of silicon- |
|---|---|---|---|
| | silicon-carbon | silicon-carbon | carbon composite |
| | composite | composite | (Formula 1) |
| Example 1 | 21.73 | 4670.51 | 0.21576 |
| Example 2 | 19.91 | 4301.67 | 0.2008 |
| Example 3 | 18.2 | 3766.4 | 0.1613 |
| Comp. Example 1 | 12.81 | 1916.5 | 0.0429 |
| Comp. Example 2 | 13.55 | 2547.2 | 0.0900 |
| Comp. Example 3 | 8.35 | 1249.1 | 0.02795 |
| Comp. Example 4 | 7.34 | 1243.84 | 0.03571 |
| Comp. Example 5 | 19 | 2300.05 | 0.033 |
| Comp. Example 6 | 23.5 | 6500 | 0.497 |
| Comp. Example 7 | 30.14 | 8705.775 | 0.726 |

For reference, Example 1 used a resin-based spherical porous carbon, and Example 2 showed a value of 0.2008 in Formula 1, which was lower than that of Example 1 (0.21576) since Example 2 was not subjected to the circularization process. In addition, since Example 3 used a biomass-derived raw material, the porous carbon exhibited relatively low mechanical strength, and thus the value in Formula 1 was measured to be 0.0429, which was lower than that of Example 1.

Comparative Example 1 used the same biomass-derived raw material as Example 3, but the presence of fine powder and the lower amount of SiH₄ deposition resulted in a larger internal pore structure in the final active material, and consequently, the value in Formula 1 was relatively low. Comparative Example 2 did not undergo the final surface carbon coating process, and Comparative Example 3 showed a relatively low value in Formula 1 due to the significantly smaller amount of SiH₄ deposition compared with Comparative Example 1. Finally, in the case of Comparative Example 4, the value in Formula 1 was also measured to be relatively low because the outermost carbon coating temperature was lower.

In addition, Comparative Example 5 did not form a carbon coating layer, as in Comparative Example 2, resulting in a decrease in the hardness value, while in Comparative Example 6, the outermost carbon coating time was extended, leading to an increase in the overall hardness value of the composite. Furthermore, in the case of Comparative Example 7, which corresponded to the carbon-coated Mg-doped silicon oxide, the modulus and hardness values were found to exceed the range defined in the present disclosure.

### <Manufacture of Negative Electrode>

A negative electrode slurry was prepared by adding a negative electrode active material including the silicon-based active material shown in Table 1, a negative electrode conductive material, and a binder made of polyacrylamide at a weight ratio of 80:10:10 to distilled water as a solvent for forming a negative electrode slurry (a solid content concentration of about 25 wt %).

In an embodiment, the negative electrode conductive material was carbon black (specific surface area: 45 m²/g, diameter: 30 nm to 50 nm).

As a mixing method, the negative electrode conductive material, binder, and water were dispersed using a homogeneous mixer at 2,500 rpm for 30 minutes, and then the silicon-based active material was added and dispersed at 2,500 rpm for 30 minutes to prepare a negative electrode slurry.

As a negative electrode current collector layer, the negative electrode slurry was coated on both sides of a copper current collector (thickness: 8 μm) with a loading amount of 85 mg/25 cm², rolled, and dried in a vacuum oven at 130° C. for 10 hours to form a negative electrode active material layer (thickness: 33 μm), which was used as a negative electrode (thickness of negative electrode: 41 μm, porosity of negative electrode: 40.0%).

### Experimental Example

A coin half-cell was fabricated using lithium metal as a counter electrode to the negative electrode for a lithium secondary battery, and charge/discharge tests were performed at a C-rate of 0.1C. Charging was carried out in CC/CV mode with a cutoff of 5 mV at 0.005C, and discharging was performed in CC mode down to 1.0 V. The results are shown in Table 2 below.

TABLE 2

| | Electrode Density | | Electrode Density | |
|---|---|---|---|---|
| | (0.9-0.99 g/cc) | | (1-1.3 g/cc) | |
| | | Initial | Capacity | Initial |
| | Capacity | Efficiency | Decrease | Efficiency |
| | (mAh/g) | (%) | Rate (%) | Decrease (%) |
| Ex. 1 | 1807 | 84.8 | 1.10 | 0.6 |
| Ex. 2 | 1932 | 87.2 | 1.19 | 0.8 |
| Ex. 3 | 1862 | 88.3 | 1.12 | 1 |
| Comp. Ex. 1 | 1890 | 87.4 | 3.70 | 0.9 |
| Comp. Ex. 2 | 1843 | 88 | 1.03 | 1.3 |
| Comp. Ex. 3 | 1680 | 83 | 4.76 | 1 |
| Comp. Ex. 4 | 1880 | 87.4 | 1.70 | 1.6 |
| Comp. Ex. 5 | 1900 | 88.6 | 0.47 | 1.5 |
| Comp. Ex. 6 | 1780 | 84.0 | 3.37 | 0.2 |
| Comp. Ex. 7 | 1348 | 77.8 | 1.71 | 0.1 |

As shown in Table 2, the rates of decrease in capacity and efficiency at an electrode density of 1 g/cc to 1.3 g/cc based on 0.9 g/cc to 0.99 g/cc for Examples and Comparative Examples of the present disclosure were recorded in Table 2, and it was confirmed that the comparative examples exhibited greater decreases than the embodiments. For example, Examples exhibited a high-capacity negative electrode (1,700 mAh/g or more) with a capacity reduction rate of about 1.2% or less and an initial efficiency reduction of about 1.0% or less, whereas Comparative Examples showed a larger deterioration in physical properties due to rolling.

In the numerical comparison of Table 2, Comparative Examples 1, 6, and 7 exhibited relatively low initial efficiency reduction but higher capacity reduction rates compared with Examples. Meanwhile, Comparative Examples 2 and 5 showed smaller capacity reduction rates but relatively greater initial efficiency reduction. Similarly, Comparative Examples 3 and 4 exhibited results similar to those of Comparative Example 1.

For reference, Comparative Example 7 used SiO, and since its hardness and modulus values were out of the range defined in the present disclosure, the overall capacity was lower than those of Examples, making it unsuitable for the intended application.

In Examples of the present disclosure, the silicon-carbon composite satisfying the physical properties shown in Table 1 was used. By employing resin-based porous carbon, the material exhibited relatively high mechanical strength and well-developed micropores. Accordingly, Examples in Table 1 showed high modulus values of about 15 GPa to 25 GPa, representing superior elastic performance before plastic deformation, smaller expansion during discharge, and more uniform formation of irreversible phases with increasing circularity, resulting in excellent efficiency characteristics.

Meanwhile, Comparative Examples employed biomass-based materials, which inherently possessed a higher proportion of mesopores and macropores characteristic of biomass. As a result, Comparative Examples exhibited inferior properties compared with Examples. Furthermore, because the total pore volume of each porous carbon differed, the amount of silicon that could be deposited also varied, leading to a lower modulus of less than about 15 GPa and thus inferior properties compared with Examples.

Additionally, hardness, which represents the resistance required to induce small localized deformation on a material's surface and indicates the ability of the surface to withstand local indentation, was also superior in Examples compared with Comparative Examples. This result implied that, under identical indentation conditions, the particles of the materials in the comparative examples fractured more severely than those in Examples.

In Examples of the present disclosure, at high rolling densities, it was inferred from the above characteristics that the electrodes exhibited fewer electrical short circuits, and as a result of these features, the reduction in efficiency was relatively small in Examples.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A negative electrode active material for a lithium secondary battery, comprising a silicon-carbon (Si/C) composite having a modulus value (A) representing the stiffness of a material of about 15 GPa to about 25 GPa, and a hardness value (B) representing resistance to scratching or indentation on a material surface of about 2,500 MPa to about 5,000 MPa.

2. The negative electrode active material for a lithium secondary battery according to claim 1, wherein the modulus value (A) and the hardness value (B) satisfy Formula 1:
$$0.1 \leq {B}^{3} / {A}^{2} . \qquad [ Formula 1 ]$$

3. The negative electrode active material for a lithium secondary battery according to claim 1, wherein the silicon-carbon composite includes a porous carbon and silicon deposited on the porous carbon,
and the silicon is included in an amount of about 40 parts by weight or more to about 60 parts by weight based on 100 parts by weight of the silicon-carbon composite.

4. The negative electrode active material for a lithium secondary battery according to claim 1, wherein the silicon-carbon composite has an average particle diameter (D50) of about 1 μm or more to about 10 μm or less.

5. The negative electrode active material for a lithium secondary battery according to claim 1, further comprising a carbon-based active material.

6. The negative electrode active material for a lithium secondary battery according to claim 1, wherein the silicon-carbon composite is included in an amount of about 80 parts by weight or less based on 100 parts by weight of the negative electrode active material.

7. A method for manufacturing a negative electrode active material, the method comprising:
preparing a porous carbon; and
depositing silicon on the porous carbon to form a silicon-carbon composite,
wherein the silicon is included in an amount of about 40 parts by weight or more to about 60 parts by weight based on 100 parts by weight of the silicon-carbon composite,
and the silicon-carbon composite has a modulus value (A) of about 15 GPa to about 25 GPa and a hardness value (B) of about 2,500 MPa to about 5,000 MPa.

8. The method according to claim 7, wherein the porous carbon is prepared from a resin-based porous carbon raw material.

9. The method according to claim 7, wherein the porous carbon has a first pore ratio of about 90% or more having a diameter of less than 2 nm as measured by a nitrogen adsorption method, and
the porous carbon has a second pore ratio of about 10% or less having a diameter of about 2 nm or more to about 50 nm or less as measured by the nitrogen adsorption method.

10. A negative electrode composition for a lithium secondary battery, comprising the negative electrode active material according to claim 1, a negative electrode conductive material, and a negative electrode binder.

11. The negative electrode composition for a lithium secondary battery according to claim 10, wherein the negative electrode active material is included in an amount of about 40 parts by weight or more based on 100 parts by weight of the negative electrode composition.

12. A negative electrode for a lithium secondary battery, comprising:
a negative electrode current collector layer; and
a negative electrode active material layer disposed on one or both surfaces of the negative electrode current collector layer,
wherein the negative electrode active material layer includes the negative electrode composition according to claim 10 or a cured product thereof.

13. The negative electrode for a lithium secondary battery according to claim 12, wherein the negative electrode current collector layer has a thickness of about 1 μm or more to about 100 μm or less, and
the negative electrode active material layer has a thickness of about 5 μm or more to about 500 μm or less.

14. A lithium secondary battery, comprising:
a positive electrode;
the negative electrode for a lithium secondary battery according to claim 12;
a separator disposed between the positive electrode and the negative electrode; and
an electrolyte.
